(19) United States
(12) Patent Application Publication
(10) Pub. No.: US 2019/0337084 A1
(43) Pub. Date: Nov. 7, 2019

(54) BUILDING CONSTRUCTION APPARATUS

(71) Applicant: Thomas Freemon, Woodland Hills, CA (US)

(72) Inventor: Thomas Freemon, Woodland Hills, CA (US)

(21) Appl. No.: 15/972,009

(22) Filed: May 4, 2018

(51) Int. Cl. B23K 11/31; B23K 11/11; B23K 9/10

(52) U.S. Cl. CPC B23K 11/318; B23K 9/1006; B23K 11/314; B23K 11/11

(57) ABSTRACT

A building construction welding apparatus is provided including a rover vehicle having at least one movable arm configured to provide spot welding functionality, the rover vehicle comprising rover drive hardware configured to transport the rover vehicle over an upper corrugated sheet of metal, a crawler configured to travel under a lower corrugated sheet of metal beneath the upper corrugated sheet of metal, the crawler provided with crawler drive hardware and a movable electrode configured to be positioned at a lower position desired weld point, and a central power/data unit connected to the rover vehicle and crawler. The rover vehicle is configured to position one movable arm above the upper corrugated sheet of metal at an upper position desired weld point corresponding to the lower position desired weld point and effectuate a welding function.

### BACKGROUND OF THE INVENTION

### Field of the Invention

The present invention relates generally to building systems, and more specifically to systems and devices used in the construction of planar structural assemblies such as floors, roofs, and walls of commercial and residential buildings.

### Description of the Related Art

Construction of buildings require a number of tasks and areas of specialization. Electrical, plumbing, framing, drywall, painting, and numerous other professionals are required to successfully construct a residential or commercial structure. Much of a building's costs can be attributed to labor costs. Any reduction in labor costs can be highly beneficial.

One aspect of concrete roof and floor construction is the lateral joining of corrugated sheets of steel. This task has traditionally and still recently been performed by a laborer using a crimping tool to bind two adjacent corrugated sheets of steel. The worker may use other common methods depending on the application, such as bolts or screws or another type of binding device or technology. When crimping, the worker must perform multiple crimping functions with the crimping tool along the edge of the corrugated sheets of steel. Similarly, when a worker employs bolts, screws, or other fasteners, he must drill or otherwise affix the fastener to the joint in multiple locations. When such joints fail, they tend to fail dramatically, such as explosively.

Such procedures tend to be time consuming and generally inefficient. The worker could be performing other tasks or could be used for less time on the job.

It would be highly beneficial if the issues associated with joining corrugated steel or other corrugated metal pieces could be performed in a manner that overcomes the issues associated with using manual labor to perform such tasks.

### SUMMARY OF THE INVENTION

The present design, in one embodiment, may include an apparatus comprising a rover vehicle comprising at least one movable arm configured to provide spot welding functionality, the rover vehicle comprising rover drive hardware configured to transport the rover vehicle over an upper corrugated sheet of metal, a crawler configured to travel under a lower corrugated sheet of metal beneath the upper corrugated sheet of metal, the crawler provided with crawler drive hardware and a movable electrode configured to be positioned at a lower position desired weld point, and a central power/data unit connected to the rover vehicle and crawler. The rover vehicle is configured to position one movable arm above the upper corrugated sheet of metal at an upper position desired weld point corresponding to the lower position desired weld point and effectuate a welding function.

According to another embodiment of the present design, there is provided a spot welding system comprising a rover vehicle comprising at least one movable arm and rover drive hardware configured to transport the rover vehicle over an upper corrugated sheet of metal, a crawler configured to travel under a lower corrugated sheet of metal beneath the upper corrugated sheet of metal, the crawler provided with crawler drive hardware and a movable electrode provided with electrode raising/lowering hardware configured to raise the movable electrode to a weld point, and a central power/data unit connected to the rover vehicle and crawler. The rover vehicle is configured to position one movable arm above the upper corrugated sheet of metal and effectuate a welding function proximate the weld point.

According to a further embodiment of the present design, there is provided a building construction spot welding apparatus comprising a rover comprising at least one movable arm and rover drive hardware configured to transport the rover vehicle over an upper corrugated sheet of metal, a crawler comprising crawler drive hardware configured to propel the crawler under a lower corrugated sheet of metal beneath the upper corrugated sheet of metal, the crawler provided a movable electrode provided with electrode raising/lowering hardware configured to raise the movable electrode toward the lower corrugated sheet of metal and toward a weld point, and a central power/data unit connected to the rover and crawler and configured to coordinate positioning between the rover, the crawler, and the weld point. The rover is configured to position one movable arm above the upper corrugated sheet of metal and effectuate a welding function proximate the weld point.

These and other advantages of the present invention will become apparent to those skilled in the art from the following detailed description of the invention and the accompanying drawings.

### BRIEF DESCRIPTION OF THE DRAWINGS

For a more complete understanding of the present disclosure, reference is now made to the following figures, wherein like reference numbers refer to similar items throughout the figures:

FIG. 1 illustrates the prior method of laterally joining sheets of corrugated metal;

FIG. 2 shows an assembled construction arrangement including corrugated metal sheets, such as steel;

FIG. 3 is a different view of FIG. 2 and represents a cross section of the sheets or layers of corrugated metal;

FIG. 4 illustrates a perspective view of one embodiment of the present design;

FIG. 5 is a top view of one embodiment of the present design;

FIG. 6 is a side view of one embodiment of the present design;

FIG. 7A is a view of a pair of robotic or movable arms in accordance with one embodiment of the present design;

FIG. 7B is a perspective view including one robotic or movable arm in accordance with one embodiment of the present design;

FIGS. 8A and 8B are a flow chart of the functionality of the present design;

FIG. 9A is a representative view of a crawler with the movable electrode retracted;

FIG. 9B is a representation of a crawler with the movable electrode deployed;

FIG. 10 illustrates a first view of one embodiment of a central processing device or computing device and associated cables;

FIG. 11 is a further view of the embodiment of the central processing device or computing device and associated cables; and

FIG. 12 shows an embodiment of the central processing device or computing device with specific features of one embodiment of the control unit or controller.

The exemplification set out herein illustrates particular embodiments, and such exemplification is not intended to be construed as limiting in any manner.

### DETAILED DESCRIPTION OF THE INVENTION

The following description and the drawings illustrate specific embodiments sufficiently to enable those skilled in the art to practice the system and method described. Other embodiments may incorporate structural, logical, process and other changes. Examples merely typify possible variations. Individual components and functions are generally optional unless explicitly required, and the sequence of operations may vary. Portions and features of some embodiments may be included in or substituted for those of others.

In general, the present invention is broadly directed to a system that travels along corrugated metal sheets, such as corrugated steel sheets, and performs spot welding at appropriate joints using a series of robotic or movable arms, a drive system that may include treads to facilitate movement over the corrugated sheets, and a crawler device generally located beneath the corrugated metal sheets. The device may be directed to a location and a number of robotic arms, such as four, may be positioned at appropriate locations relative to the corrugated metal seam and may spot-weld the sheets together using the known position of the crawler. In one aspect, the crawler and the device may be connected to a central power source and/or computing device such that the crawler operates below the corrugated metal in concert with the device operating above the corrugated metal.

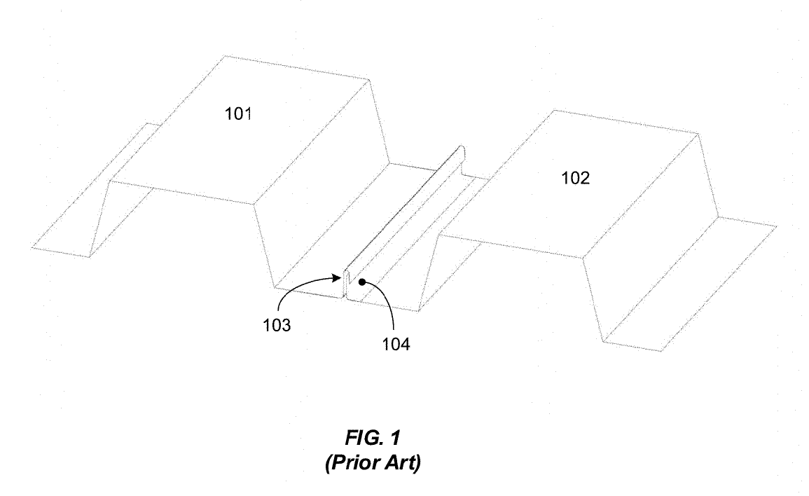

FIG. 1 illustrates the issue with corrugated metal. From FIG. 1, two corrugated metal sheets 101 and 102 are provided, and the traditional method has been to crimp edge 103 of corrugated metal sheet 101 over edge 104 of corrugated metal sheet 102. Crimping in this manner can require significant manual effort and must be done the length of the corrugated metal sheet, which can vary in size but may be 10 feet or more.

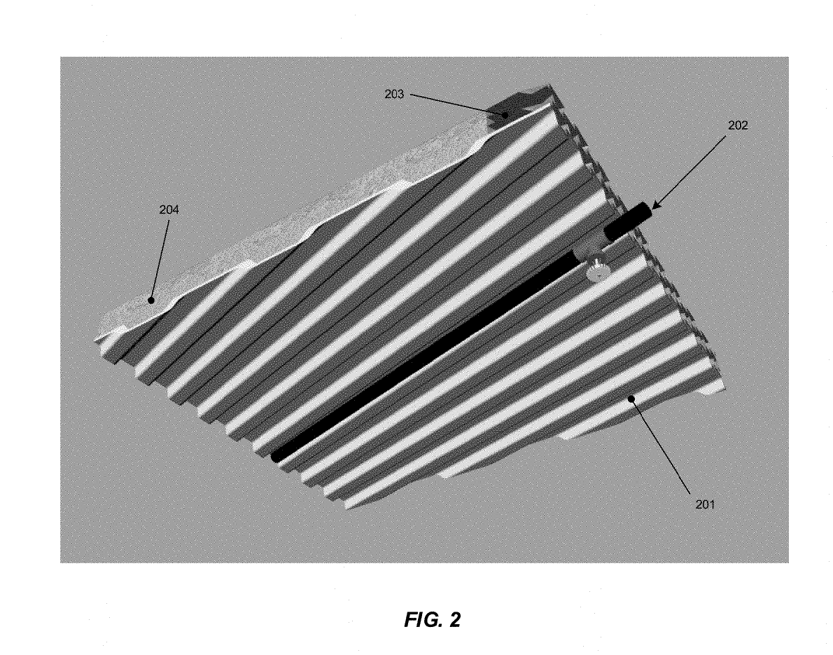

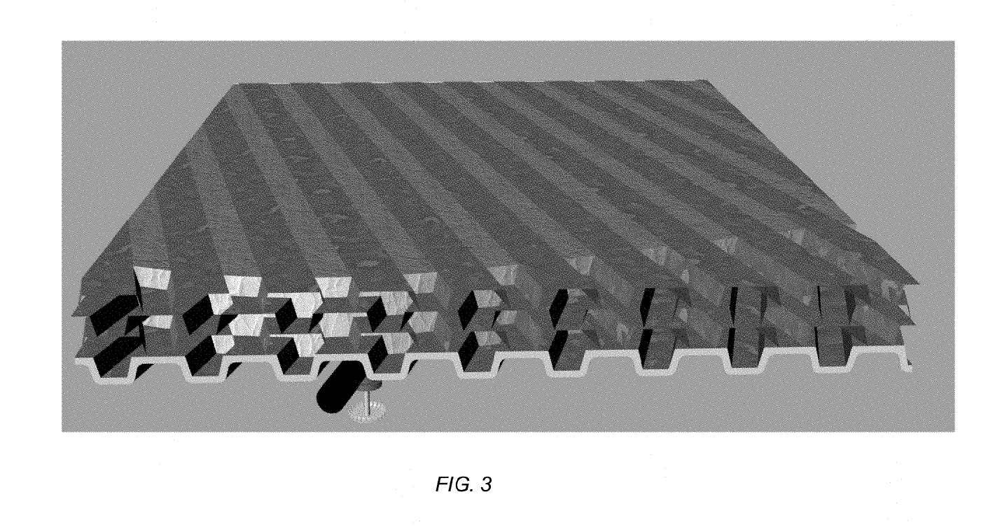

FIG. 2 is a cross section of typical corrugated steel when installed in a commercial building setting. From FIG. 2, corrugated metal 201 will typically include a “monocoat” spray-on fireproofing. Utility line 202 is shown, which in this representation is a fire sprinkler installed below the assembly. The layers of sheets 203 represent multiple layers of corrugated steel sheets, shown in profile in FIG. 3. In FIG. 2, an expanding structural foam reinforcement layer 204 is shown representing structural foam provided to the stacked sheets of corrugated steel. FIG. 3 is a side view of three layers of corrugated steel and a utility line below, where the three layers may ultimately be provided with expanding structural foam reinforcement.

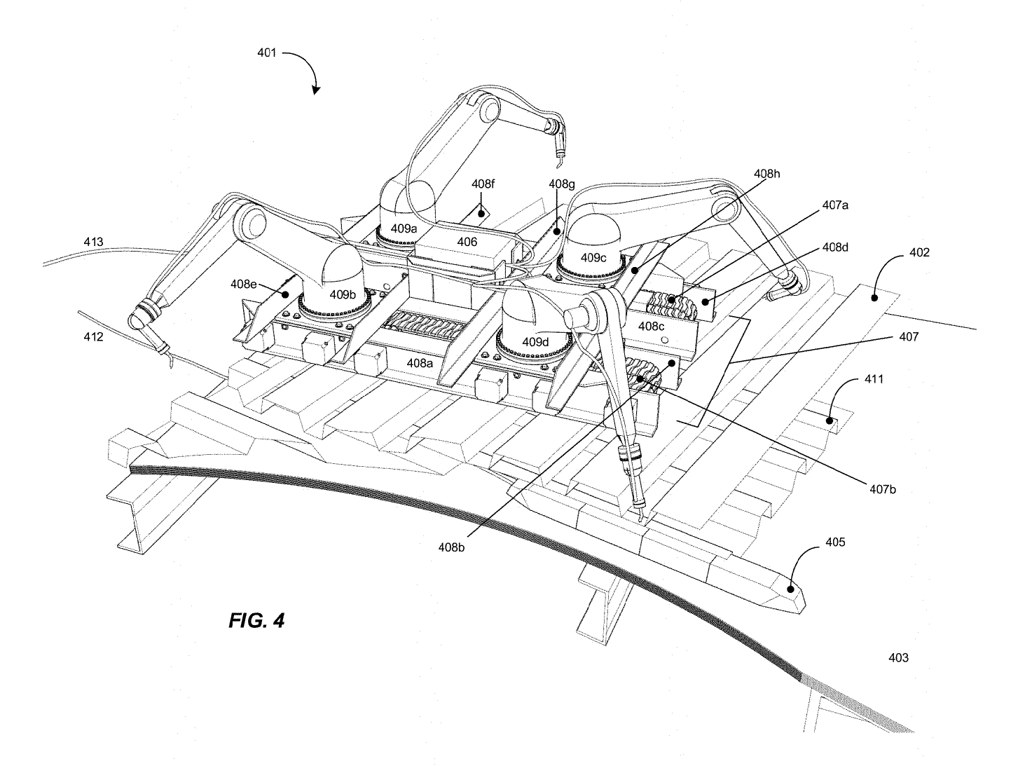

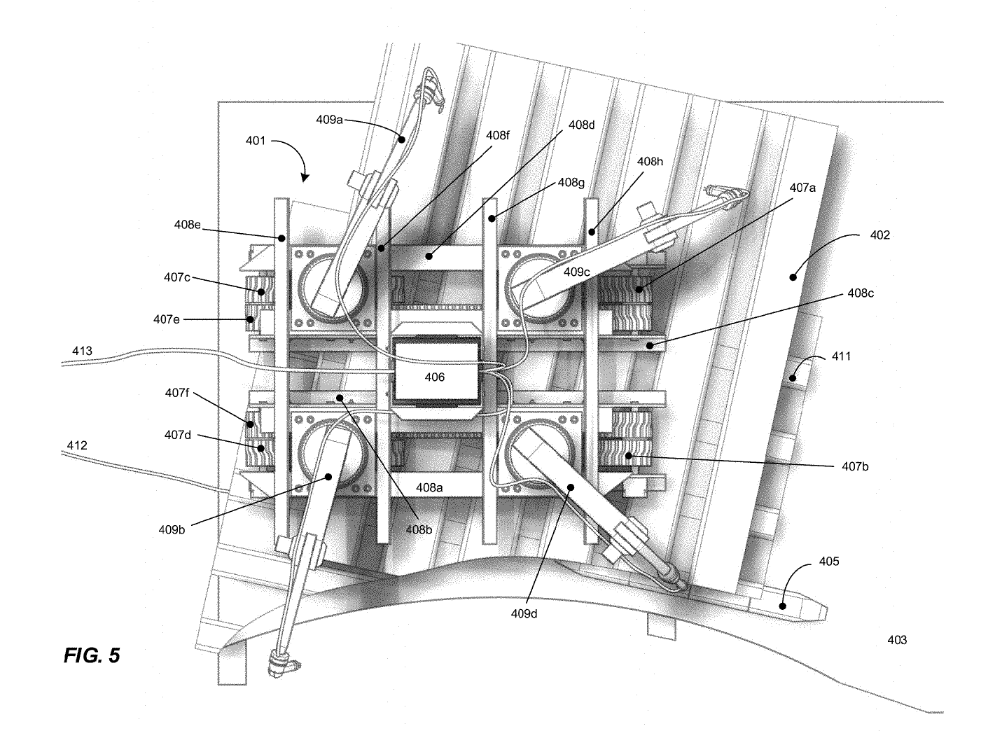

FIG. 4 illustrates the present design, which includes rover 401 traveling over corrugated metal surface 402, which in this view is over flooring 403 and support elements 404a and 404b. Also shown is crawler 405 which travels beneath rover 401 to facilitate positioning of the robotic arms ad spot welding devices provided. The position of crawler 405 is subservient to the motion of the 6-DOF arm to which it is presently assigned. A central rover controller 406 is provided that controls the robotic arms and the moving system 407, which in this embodiment comprises front right tread 407a and front left tread 407b. Rear right and left treads are not shown in this view but can be seen in FIG. 5; while four are contemplated in this embodiment, more or fewer, such as two long treads, may be employed, and other drive means, such as wheels, may be provided.

In this embodiment, supports 408a, 408b, 408c, and 408d are provided, together with cross pieces 408e, 408f, 408g, and 408h. Four six degree of freedom (6-DOF) robotic arms 409a, 409b, 409c, and 409d are provided in this embodiment, but any number of such robotic arms or similar spot welding movable devices may be provided. In this view, crawler 405 is moving in one direction beneath a lower sheet of corrugated metal 411 while upper corrugated metal sheet 402 is located thereon with openings or channels oriented perpendicular to the openings or channels of the lower sheet of corrugated metal 411. In this manner, a connection can be formed to enable spot welding. The crawler assists in positioning the spot welding joint as will be described.

Spot welding is generally understood to employ copper alloy electrodes to be positioned on both sides of a metal joint. Current is applied and the applied current heats the “spot” and causes the metal to melt and form a spot weld button created between the two sheets. In the configuration of FIG. 4, the crawler 405 provides the lower electrode, connected via the return path conductor or data/power cable 412 to a central processing device or computing device (not shown). Second data/power cable 413 provides power and data to central rover controller 406. In the case of crawler 405 and data/power cable 412, an electrode located in crawler 405 is raised to meet the lower corrugated steel sheet 411, one robotic arm lowers its electrode to the top of the upper corrugated metal sheet 402, and the central processing device or computing device applies current to form the spot weld. In this arrangement, the crawler 405 can pass through the opening formed by the corrugated metal sheet and binding, rather than occurring on a seam as had been previously done, occurs by spot welding an upper sheet and a lower sheet at horizontal points here they intersect or are flatly located against one another. The crawler 405 may go forward and back through the channel so formed using appropriate drive means, such as wheels, and may be removed or repositioned within any channel where spot welds are to be made.

FIG. 5 illustrates a top view of the rover. The 6-DOF arms 409a-d rotate atop metal plates and are bolted to rotating elements (not shown). The supports and cross pieces 408a-h are in this configuration generally L-shaped, but any shape may be employed that is appropriate under the circumstances. As can be seen from FIG. 5, each of the 6-DOF arms 409a-d is connected by wire to central controller 406, which is then connected to a remote computing device (not shown) by cable 413, and the remote computing device may be connected to crawler 405 by cable 412. Rear treads 407c and 407d are shown in this view.

The function of central rover controller 406 is to control the four 6-DOF arms and the drive system such as the four treads shown in FIG. 5. In operation, positional information may be provided to the central rover controller 406 about location on the upper corrugated metal sheet 402, and may have information about the upper corrugated metal sheet 402 such as dimensions of the channels and/or protrusions. A sensor or sensors may be provided, such as an optical sensor, to determine current position of rover 401. Based on the known position of the rover and the known position of crawler 405, as well as the shape of the upper corrugated metal sheet 402, the central rover controller 406 may command the individual 6-DOF arms to move to a desired orientation to place the tip on the individual 6-DOF arm on the desired joint.

Note that based on the position of the crawler 405 and the location of the grooves and size of the grooves on the lower corrugated metal sheet 411, the system, such as central rover controller 406, may position 6-DOF arms 409a-d and the tips of such in position to facilitate a spot weld, such as on a known groove in the upper corrugated metal sheet and a known protrusion in the upper corrugated sheet. In other words, positional information of the rover 401 and components thereof as well as crawler 405 and the corrugated metal sheets are employed and desired positions determined as the rover 401 progresses and performs spot welds.

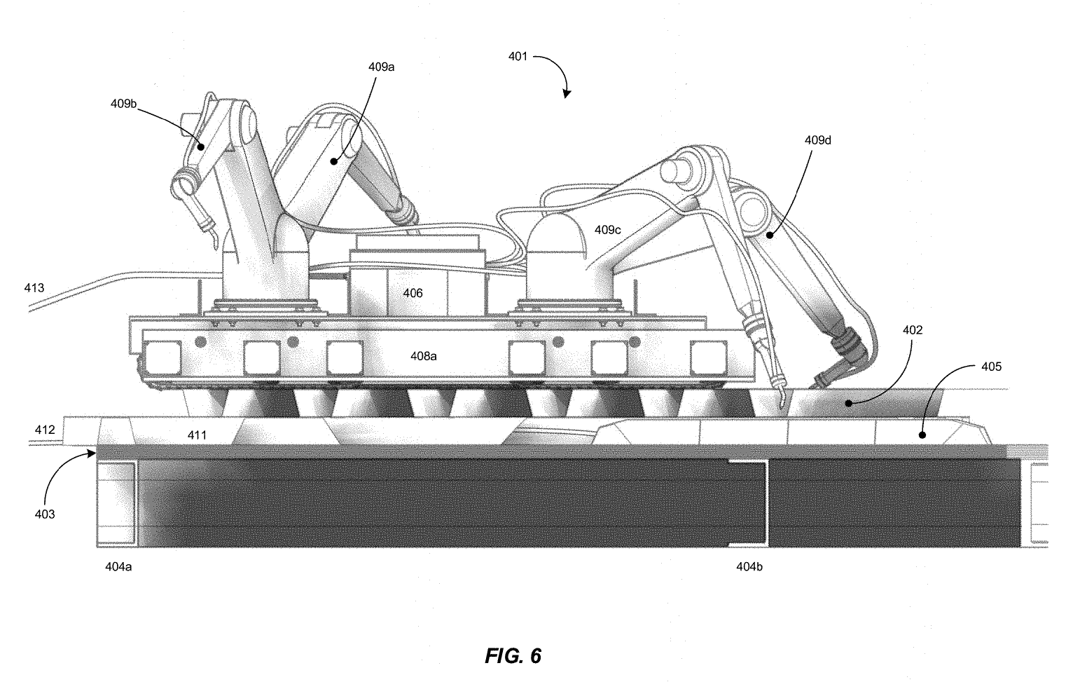

FIG. 6 is a side view of rover 401 including the various components disclosed and discussed with respect to FIGS. 4 and 5. Note that in FIG. 6 the bolts affixing arms 409b and 409d to the rover are illustrated, and again, these 6-DOF arms may rotate to position the tips used to spot weld the corrugated metal sheets together. Further, FIG. 5 shows a tread arrangement wherein outermost treads (407a and 407c, for example) are split into two treads, a forward tread 407a and a rear tread 407c, while the innermost treads, as shown in the center portion of the vehicle, include a single, long tread, resulting in a total of six driven treads in this arrangement 407a-f. Other drive systems may be employed, as may other tread combinations.

Movement may general be in a linear manner, however, the drive system may cause the rover 401 to rotate, such as by applying forward motion to one side and reverse motion to the opposite.

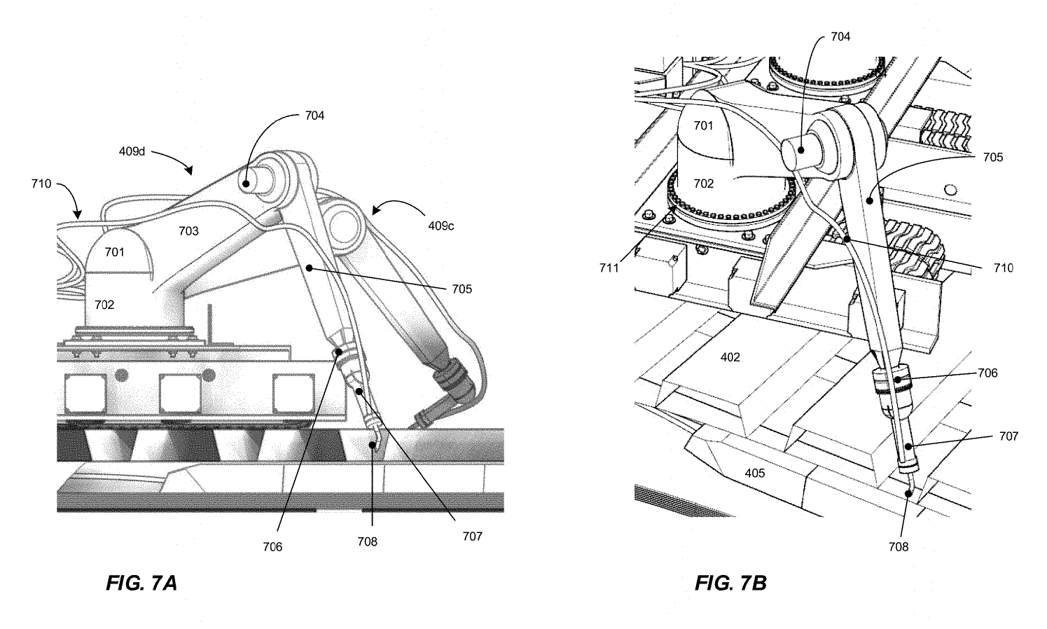

FIG. 7A is a close view of 6-DOF arms 409d 409c. Such arms are representative of 6-DOF arms that may be employed, and such arms may appear differently than those shown in FIGS. 7A and 7B. From the embodiment shown in FIG. 7A, arm 409d includes rotating element 702, cap 701 which rotates horizontally and enables up-and-down rotation of arm 703 (suggested by the interface between cap 701 and arm 703). Also provided is rotational axis element 704 used to rotate arm element 705 relative to arm 703.

The process of spot welding is generally known, and collar 706, weld element 707, and tip 708 may be constructed in accordance with known spot welding designs and may include electronics and welding materials, and line 710 provides commands and power to weld element 707 and tip 708 as well as any other necessary components in 6-DOF arm 409d. Similar components are provided with each 6-DOF arm in this embodiment. As noted, spot welding employs a copper alloy, provided in or with the 6-DOF arm and tip includes an electrode. The system, such as central rover controller 406, may apply current at an appropriate time and may effectuate the weld. Such weld arms are generally used in the automotive industry, though not always in the precise 6-DOF arm arrangement shown. FIG. 7B illustrates an alternate view of 6-DOF arm 409d and shows attachment bolts 711.

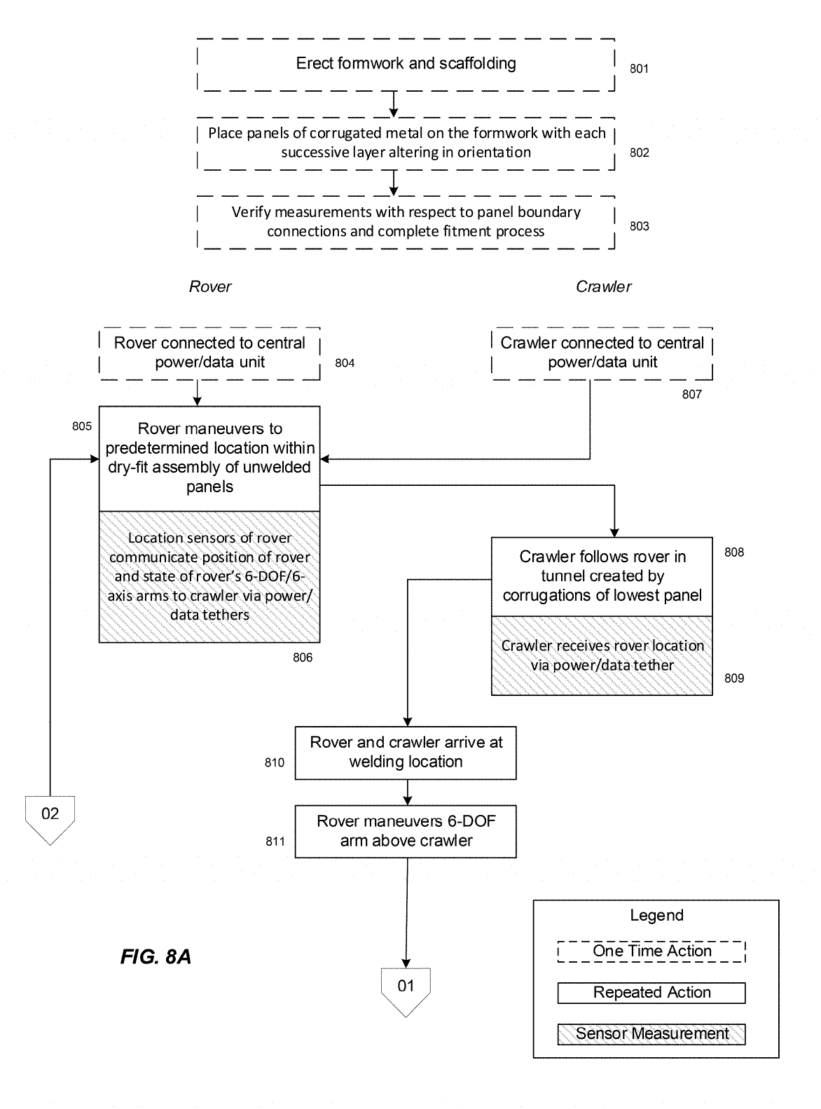

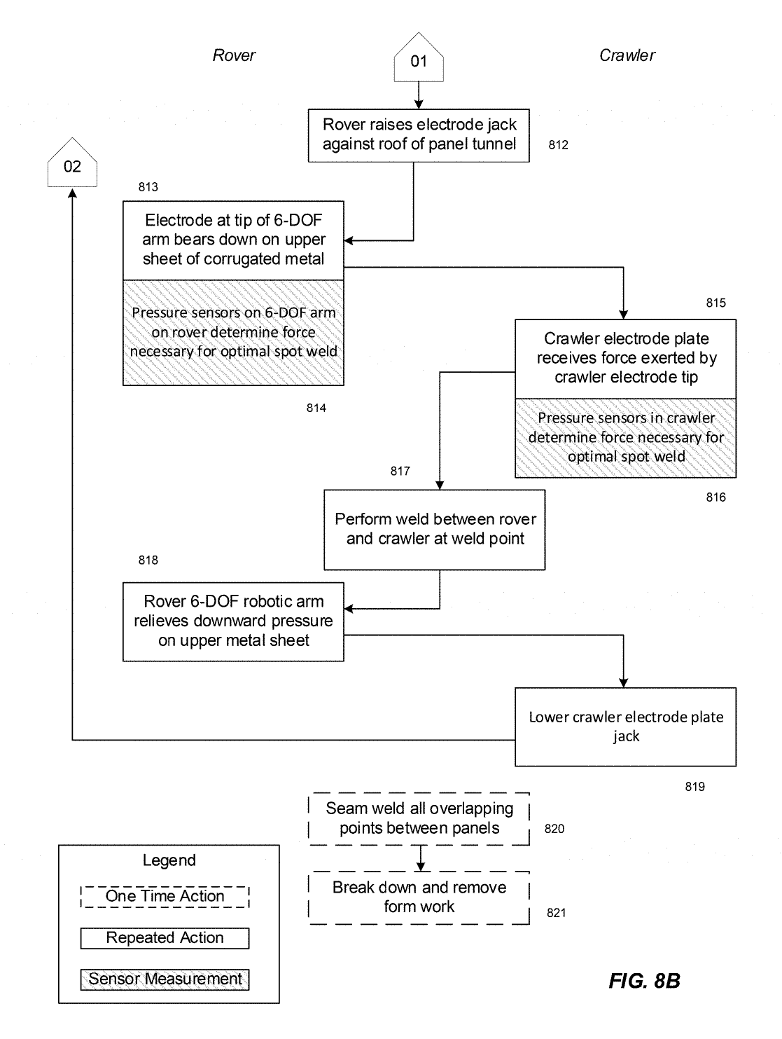

FIGS. 8A and 8B represent a general flow chart of operation of the present device. From FIG. 8A, formwork and scaffolding are erected at point 801, representing a one-time procedure. At point 802, the system places panels of corrugated metal on the formwork with each successive layer altering in orientation. While perpendicular channels are suggested, other orientations may be employed. Point 803 calls for verifying measurements with respect to panel boundary connections and calls for completing the fitment process. Points 801-803 represent one time actions.

Below point 803, the representation is generally split into rover functions on the left and crawler functions on the right, with common functions in the center. Point 801 calls for the rover to be connected to a central power/data unit, while point 807 calls for the crawler to be connected to the central power/data unit. At point 805, the rover maneuvers to a predetermined location within a dry-fit assembly of unwelded panels, while point 806 calls for the location sensors of the rover to communicate the position of the rover and the state of the rover's 6-axis arms to the crawler via the power/data tethers and the central power/data unit. Point 808 calls for the crawler to follow the rover in the groove or tunnel created by corrugations of the lowest panel. Point 809 calls for the crawler to receive the rover location via the power/data tether. At point 810, the rover and crawler may arrive at the welding location. At point 811, the rover may maneuver the 6-DOF arm above the crawler. Note that points “01” and “02” represent connections to lines in FIG. 8B.

From FIG. 8B, after at point 811 the rover maneuvers the 6-DOF arm above the crawler, at point 812 the rover raises its electrode jack against the “roof” of the panel tunnel, representing the upper protrusion where the crawler is located. At point 813, the electrode at the tip of the 6-DOF arm bears down or is forced, based on commands from the central rover controller 406 and/or central power/data unit, on the upper sheet of corrugated metal in a position that facilitates spot welding. At point 814, pressure sensors provided on the 6-DOF arm on the rover determines the force required for a best spot weld, and the central rover controller 406 and 6-DOF arm effectuate application of such force. At point 815, the crawler electrode plate receives force exerted by the crawler electrode tip, while at point 816 the pressure sensors in the crawler are used to determine the force necessary for a best spot weld and the crawler in combination with the central power/data unit determine the requisite force and apply the requisite force using the crawler electrode jack. At point 817, the system performs the spot weld at the intersection/location between the rover and crawler. At point 818, the rover 6-DOF arm relieves downward pressure on the upper metal sheet, and at point 819 the system lowers the crawler electrode plate jack. At this point, the system cycles back to point 805 and repeats the process as necessary until all spot welds have been completed.

At point 820, the system seam welds all overlapping points between panels using the appropriate 6-DOF arm(s), and at point 821 form work may be broken down and removed.

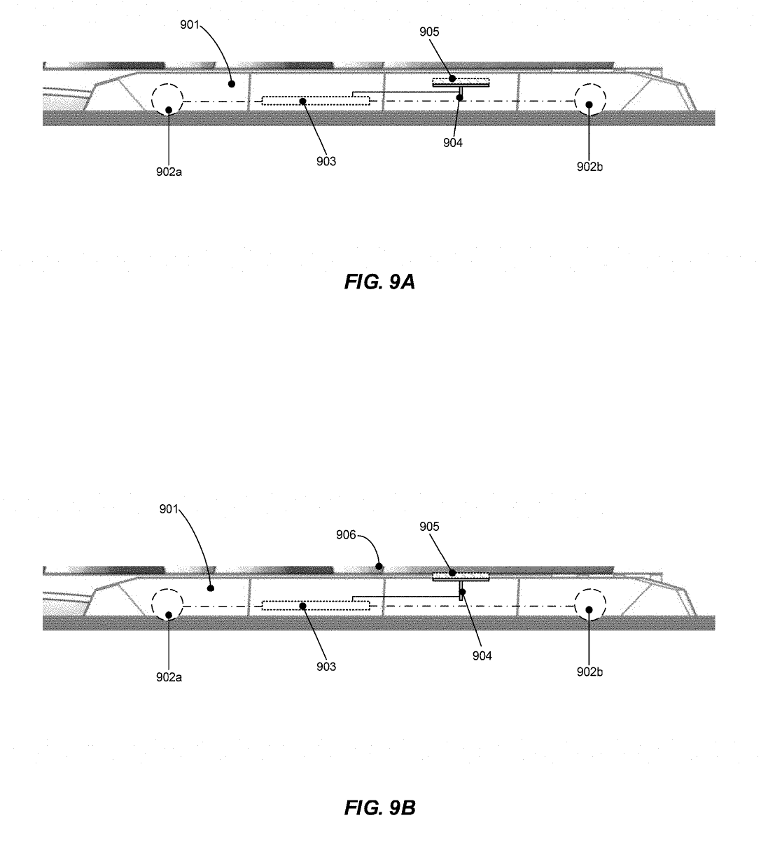

FIG. 9A illustrates one aspect of the crawler with its electrode plate hidden below the upper surface, while FIG. 9B shows the electrode plate elevated using, in this embodiment, an electrode plate jack. From FIG. 9A, there is provided a drive system in crawler 901, where the drive system may be any appropriate drive system, where in this embodiment wheels 902a and 902b are shown. Treads or other propelling means may be provided. The wheels in this view are shown controlled by crawler controller 903, which is optional in that control may be provided from the central power/data unit. Crawler controller 903 is shown in communication with electrode jack 904, which raises and lowers electrode 905 as appropriate. FIG. 9A shows the electrode 905 and electrode jack 904 in a retracted position such that the crawler can move as discussed herein within the channels and protrusions of a lower corrugated metal sheet 906. FIG. 9B shows the components with force applied to electrode jack 904 thus raising electrode 905 to be in forced contact with corrugated metal sheet 906. FIGS. 9A and 9B are generally representative of devices employed, which may take different forms than those presented. Control may be provided from a remote device or location, as may the power and commands to drive the crawler drive mechanism, such as wheels, and such power and control may be received at the crawler from the central power/data unit. However, in virtually all embodiments, an electrode is selectively retracted and deployed to provide for spot welding as described herein.

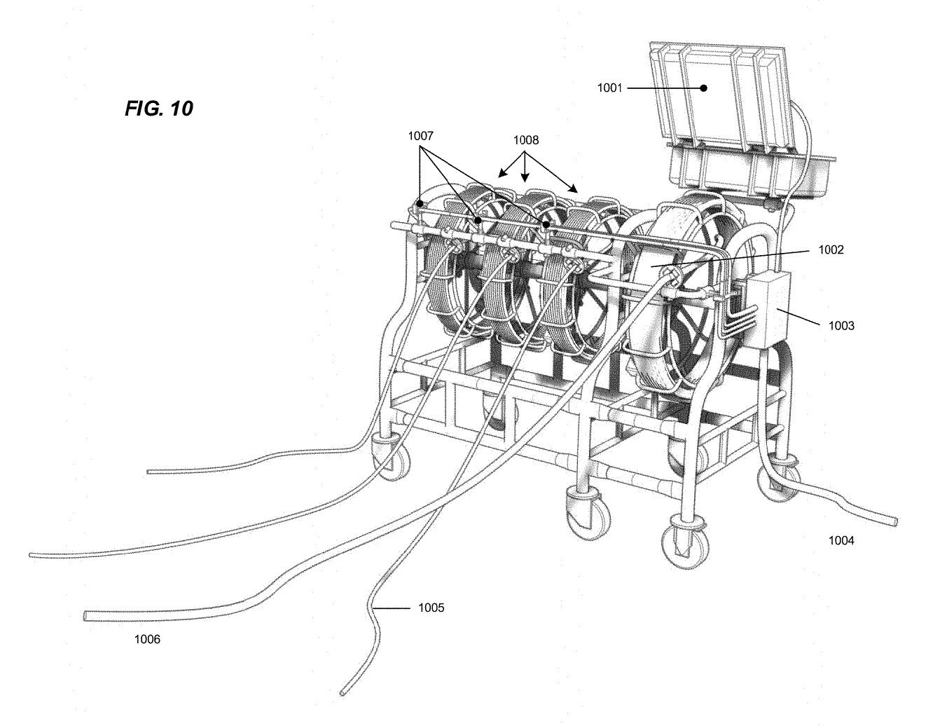

FIG. 10 illustrates a first representation of a control unit that may be employed with the present design. From FIG. 10, there is provided a computation unit 1001 configured to collect information, make determinations, and transmit signals controlling the components of the design as discussed herein. Generally, the computation unit receives signals from the rover and crawler, determines when a welding event is called for and determines desired positions of the various components, and commands the rover and crawler to operate. Rover cable spool 1002 controls distribution of the cable 1006 connected to the rover, while breaker box 1003 directs power and data to individual lines when received from computation unit 1001. Line 1004 represents a power cable, in one embodiment comprising a 220V, 30 A line. Line 1005 represents the crawler return path power and data line, while raceway 1007 directs power and commands from breaker box 1003 to the spools 1008 and the individual cables.

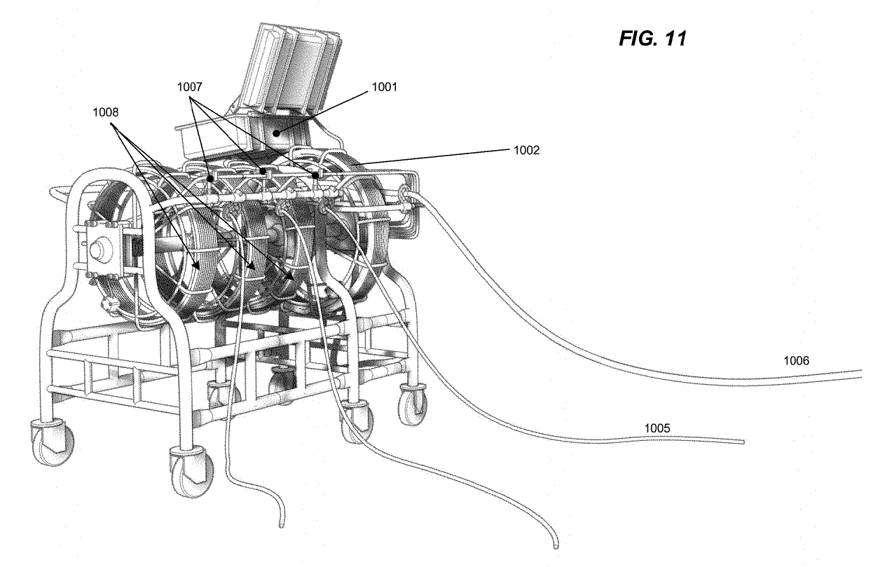

FIG. 11 is an alternate view of the control unit, showing various components from FIG. 10. The design is on wheels in this configuration, and it is to be understood that other cable deployment arrangements and other computational devices or alternate devices may be provided.

While the representations of FIGS. 10 and 11 indicate the control unit may include a computation unit 1001 having controls for a user to direct the rover and/or crawler, it is contemplated, as disclosed herein, that automatic control will be provided. In other words, the rover and crawler may be controlled automatically without user intervention. Manual control by an operator or user may be used as an override or alternative to automatic control. With regard to control operation, governing factors shaping the automatic control of the system are as follows.

The apparatus hierarchy for interaction of the superior rover and return path crawler include the superior rover (SR) movement governing the movement of all other movable and controlled components of the system. Each of the return path crawlers (RPC), including one or more such RPCs, move in accordance with the movement of the 6-DOF arm that they are assigned to at the time. As the 6-DOF arm can travel much faster than an RPC and may interact with multiple RPCs, each RPC may travel in advance of the 6-DOF arm, arriving at the next weld point in an orientation ready to effectuate a weld. As the SR has freedom to rotate 180 degrees, it may reassign 6-DOF arms to different RPCs confined to their respective corrugation tunnels. When a 6-DOF arm is lowered into position above an RPC, that RPC then raises its electrode jack against the roof of its corrugation tunnel.

Certain finished panel performance factors govern apparatus choreography. For example, with respect to weld density, spot weld concentration typically does not exceed approximately or exactly two welds per square inch. Thicker material or material with various corrugation profiles have differing weld periods and different overall masses and impact the weld density specified. The controller or control unit may assess and account for such issues. The orientation of the corrugations of successive layers of the sheet metal may vary depending on dimensions of the span. For example, layers with an angular offset of 90 degrees may be ideally suited for a square deck area. By contrast, a long rectangular deck area may have ridges of the corrugation oriented to run the short length of the area, with an offset of less than or different from 90 degrees. Larger spans typically require additional layers of sheet metal for added strength. Control of the various components require this information, i.e. angular orientation of the openings and/or travel path of the RPCs, which may be sensed if sensing is available or may be provided by an operator or otherwise.

Again, in operation, the RPC position is known, and once in an advantageous weld position, the SR may be repositioned and/or the appropriate 6-DOF arm located above the RPC and a weld sequence initiated. 6-DOF arm movement may be in any appropriate manner, such as by rotating the arm and components of the arm, and/or laterally or vertically or otherwise linearly moving the elements of the arm into position.

In FIGS. 10 and 11, it should be noted that there may, and in many cases will, be multiple RPCs assigned to each SR, and these Figures are configured for three RPCs for one SR. In all instances, there will be at least one such RPC assigned to an SR.

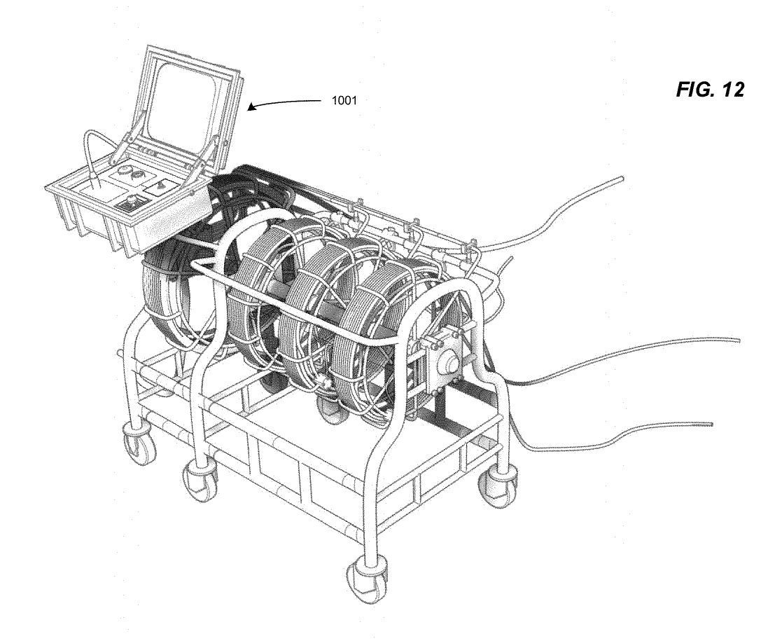

FIG. 12 illustrates another view of an embodiment of the control unit highlighting certain components of the computation unit 1001. From FIG. 12, the present design may include a joystick, touchscreen display, an emergency start/stop button, an access key allowing for apparatus activation, and a data connection to the breaker box.

Also note that while a single crawler is provided in the embodiments shown herein, multiple crawlers may be employed and the design is not so limited. Note also that while two layers of corrugated metal sheets are contemplated, the present design may be employed to weld more than two layers together as long as the crawler or crawlers can fit within the various corrugated channels of one lower level.

The present design, in one embodiment, may include an apparatus comprising a rover vehicle comprising at least one movable arm configured to provide spot welding functionality, the rover vehicle comprising rover drive hardware configured to transport the rover vehicle over an upper corrugated sheet of metal, a crawler configured to travel under a lower corrugated sheet of metal beneath the upper corrugated sheet of metal, the crawler provided with crawler drive hardware and a movable electrode configured to be positioned at a lower position desired weld point, and a central power/data unit connected to the rover vehicle and crawler. The rover vehicle is configured to position one movable arm above the upper corrugated sheet of metal at an upper position desired weld point corresponding to the lower position desired weld point and effectuate a welding function.

According to another embodiment of the present design, there is provided a spot welding system comprising a rover vehicle comprising at least one movable arm and rover drive hardware configured to transport the rover vehicle over an upper corrugated sheet of metal, a crawler configured to travel under a lower corrugated sheet of metal beneath the upper corrugated sheet of metal, the crawler provided with crawler drive hardware and a movable electrode provided with electrode raising/lowering hardware configured to raise the movable electrode to a weld point, and a central power/data unit connected to the rover vehicle and crawler. The rover vehicle is configured to position one movable arm above the upper corrugated sheet of metal and effectuate a welding function proximate the weld point.

According to a further embodiment of the present design, there is provided a building construction spot welding apparatus comprising a rover comprising at least one movable arm and rover drive hardware configured to transport the rover vehicle over an upper corrugated sheet of metal, a crawler comprising crawler drive hardware configured to propel the crawler under a lower corrugated sheet of metal beneath the upper corrugated sheet of metal, the crawler provided a movable electrode provided with electrode raising/lowering hardware configured to raise the movable electrode toward the lower corrugated sheet of metal and toward a weld point, and a central power/data unit connected to the rover and crawler and configured to coordinate positioning between the rover, the crawler, and the weld point. The rover is configured to position one movable arm above the upper corrugated sheet of metal and effectuate a welding function proximate the weld point.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. An apparatus, comprising:
a rover vehicle comprising at least one movable arm configured to provide spot welding functionality, the rover vehicle comprising rover drive hardware configured to transport the rover vehicle over an upper corrugated sheet of metal;
a crawler configured to travel under a lower corrugated sheet of metal beneath the upper corrugated sheet of metal, the crawler provided with crawler drive hardware and a movable electrode configured to be positioned at a lower position desired weld point; and
a central power/data unit connected to the rover vehicle and crawler;
wherein the rover vehicle is configured to position one movable arm above the upper corrugated sheet of metal at an upper position desired weld point corresponding to the lower position desired weld point and effectuate a welding function.

2. The apparatus of claim 1, wherein the rover drive hardware comprises at least one of a tread system and a driven rover vehicle wheel, and the crawler drive hardware comprises at least one crawler wheel.

3. The apparatus of claim 1, wherein the central power/data unit is configured to coordinate positioning between the rover vehicle, the upper position desired weld point, the crawler, and the lower position desired weld point.

4. The apparatus of claim 1, wherein grooves of the upper corrugated sheet of metal are aligned differently than grooves of the lower corrugated sheet of metal, and the upper position desired weld point is in a trough of the upper corrugated sheet of metal and the lower position desired weld point is in a protrusion of the lower corrugated sheet of metal.

5. The apparatus of claim 1, wherein the crawler comprises an electrode jack configured to raise and lower the electrode toward and away from the lower position desired weld point.

6. The apparatus of claim 1, further comprising a rover vehicle control unit configured to control the at least one movable arm based on commands received from the central power/data unit.

7. The apparatus of claim 1, wherein the rover vehicle comprises at least one sensor used to sense current position of the rover vehicle relative to the upper corrugated sheet of metal.

8. A spot welding system, comprising:
a rover vehicle comprising at least one movable arm and rover drive hardware configured to transport the rover vehicle over an upper corrugated sheet of metal;
a crawler configured to travel under a lower corrugated sheet of metal beneath the upper corrugated sheet of metal, the crawler provided with crawler drive hardware and a movable electrode provided with electrode raising/lowering hardware configured to raise the movable electrode to a weld point; and
a central power/data unit connected to the rover vehicle and crawler;
wherein the rover vehicle is configured to position one movable arm above the upper corrugated sheet of metal and effectuate a welding function proximate the weld point.

9. The spot welding system of claim 8, wherein the rover drive hardware comprises at least one of a tread system and a driven rover vehicle wheel, and the crawler drive hardware comprises at least one crawler wheel.

10. The spot welding system of claim 8, wherein the central power/data unit is configured to coordinate positioning between the rover vehicle, the weld point, and the crawler.

11. The spot welding system of claim 8, wherein grooves of the upper corrugated sheet of metal are aligned differently than grooves of the lower corrugated sheet of metal, and the upper position desired weld point is in a trough of the upper corrugated sheet of metal and the lower position desired weld point is in a protrusion of the lower corrugated sheet of metal.

12. The spot welding system of claim 8, wherein the electrode raising/lowering hardware comprises an electrode jack configured to raise and lower the electrode toward and away from the weld point.

13. The spot welding system of claim 8, further comprising a rover vehicle control unit configured to control the at least one movable arm based on commands received from the central power/data unit.

14. The spot welding system of claim 8, wherein the rover vehicle comprises at least one sensor used to sense current position of the rover vehicle relative to the upper corrugated sheet of metal.

15. A building construction spot welding apparatus, comprising:
a rover comprising at least one movable arm and rover drive hardware configured to transport the rover vehicle over an upper corrugated sheet of metal;
a crawler comprising crawler drive hardware configured to propel the crawler under a lower corrugated sheet of metal beneath the upper corrugated sheet of metal, the crawler provided a movable electrode provided with electrode raising/lowering hardware configured to raise the movable electrode toward the lower corrugated sheet of metal and toward a weld point; and
a central power/data unit connected to the rover and crawler and configured to coordinate positioning between the rover, the crawler, and the weld point;
wherein the rover is configured to position one movable arm above the upper corrugated sheet of metal and effectuate a welding function proximate the weld point.

16. The building construction spot welding apparatus of claim 16, wherein the rover drive hardware comprises at least one of a tread system and a driven rover wheel, and the crawler drive hardware comprises at least one crawler wheel.

17. The building construction spot welding apparatus of claim 16, wherein grooves of the upper corrugated sheet of metal are aligned differently than grooves of the lower corrugated sheet of metal, and the weld point is proximate a trough of the upper corrugated sheet of metal and also proximate a protrusion of the lower corrugated sheet of metal.

18. The building construction spot welding apparatus of claim 16, further comprising a rover control unit configured to control the at least one movable arm based on commands received from the central power/data unit.

19. The building construction spot welding apparatus of claim 16, wherein the rover comprises at least one sensor used to sense current position of the rover relative to the upper corrugated sheet of metal.
